(19) United States
(12) Patent Application Publication
(10) Pub. No.: US 2017/0147703 A1
(43) Pub. Date: May 25, 2017

(54) METHOD AND APPARATUS FOR DYNAMICALLY DISPLAYING YELLOW PAGES INFORMATION ON MOBILE DEVICE

(71) Applicants: Le Holdings (Beijing) Co., Ltd., Beijing (CN); Le Shi Zhi Xin Electronic Technology (Tianjin) Limited, Tianjin (CN)

(72) Inventor: Dan JIANG, Tianjin (CN)

(21) Appl. No.: 15/245,157

(22) Filed: Aug. 23, 2016

Related U.S. Application Data
(63) Continuation of application No. PCT/CN2016/085176, filed on Jun. 7, 2016.

(30) Foreign Application Priority Data
Nov. 23, 2015 (CN) 201510819326.1

(51) Int. Cl. G06F 17/30

(52) U.S. Cl. CPC G06F 17/30923; G06F 17/30887

(57) ABSTRACT

Embodiments of the present disclosure provide a method and apparatus for dynamically displaying yellow pages information on a mobile device. The method comprises: pre-caching yellow pages information and a defined yellow-pages home page under a raw folder; displaying the cached yellow-pages home page on a client when a user operates the client, and acquiring the yellow pages information under the raw folder and storing the yellow pages information to a client database; and requesting, by the client, the yellow pages information from a server over the network when the mobile device is connected to a network, and searching in the client database according to partial yellow pages information returned by the server to acquire complete yellow pages information and display the acquired complete yellow pages information.

### CROSS REFERENCE TO RELATED APPLICATIONS

This present disclosure is a continuation of International Application No. PCT/CN2016/085176, filed Jun. 7, 2016, which claims priority to Chinese Patent Application No. 201510819326.1, filed Nov. 23, 2015, the entire contents of all of which are incorporated herein by reference.

### TECHNICAL FIELD

The disclosure relates to the technical field of mobile devices, and more particularly, to a method and apparatus for dynamically displaying yellow pages information on a mobile device.

### BACKGROUND

Yellow pages is a telephone directory of business enterprises which are sorted according to enterprise nature and product category based on an internationally universal standard. Yellow pages mainly contains published enterprise names, enterprise addresses, enterprise telephone numbers, which is equivalent to a residential register of the business enterprises in a city or region. Yellow pages information is printed on yellow papers according to international practices, and thus called yellow pages. Free China yellow pages, enterprise lists, business guidelines, consumer guidelines and the like which are prevailing over the Internet at present may be considered as various exhibition forms of yellow pages.

Yellow pages is a medium which provides most direct contact information for communication between enterprises and consumers. From the perspective of the contents, yellow pages is closely correlated to people's life, which provides most direct contact information, i.e. telephone numbers, and enlists basic contents desired by general residential users for living and consumption. Such basic contents include: clothing, food, housing and transportation, entertainment, sports and body-building, cultural education, medical treatments, transportation, communication, welfare, tourism, shopping and the like, which are closely correlated to people and life, bring convenience to life and consumption, and play a role of guiding people's life and consumption. Therefore, different from the manner in which most media directly exhibit advertisement information to the audiences, the advertisements and the like business information released on the yellow pages is in full coincidence with the purchase intensions of the consumers, and relevant information of the enterprises is suitably provided when the consumers searches for telephone numbers. Therefore, the yellow pages information becomes a device link based on which the consumers make purchase decisions, and finally promotes the purchases of the consumers. Hence, during the decision making process of the consumers, the yellow pages information plays a uniquely important role.

Smart devices, such as mobile phones, are generally equipped with a yellow pages application. As illustrated in FIG. 1, the traditional yellow pages is migrated to the mobile phones, and the mobile phones serve as a carrier for releasing, propagating a telephone number book of the applicant. As such, anywhere and anytime, where necessary, the users may conveniently query basic information, brief introduction or service introduction of their interested enterprises. This is a new form of yellow pages based on the development of the mobile Internet and 3G network. With the high-speed development of mobile phones and mobile phone networks in recent years, mobile phone yellow pages inevitably becomes the mainstream of the yellow pages, or even would replace the traditional yellow pages. This is because, in one aspect, users have demands on searching for the nearby foods, banks and gas stations and the like, and in another aspect, with the development of the smart phones and the improvement of stability and speed of the mobile phone network, the hardware of the mobile phones is already capable of supporting development requirement of yellow pages.

The yellow pages application is mainly for information query. The users may query the nearby restaurants, hotels and gas stations, or may find the nearest KFCs according to a keyword, such as KFC, or may know the intensions of incoming calls, for example, product promotions, express deliveries or cheatings according to relevant telephone numbers released in the yellow pages.

From the perspective of service providers, the sequence of data displayed in the yellow pages is very important. For example, within a specific period of time, financial services may be firstly recommended, whereas sometimes travel and tourism services may be firstly recommended. Therefore, it is desired that the yellow pages interfaces presented to the users are dynamically adjustable, rather than being displayed in a fixed mode and fixed sequence. For example, banks are currently displayed firstly, and the travel and tourism services may be may be firstly displayed next time; or under the same financial services, Bank of China is currently displayed firstly, and Beijing Bank may be firstly displayed next time.

In a conventional solution, to display all the data as illustrated in FIG. 1, since the data is not displayed in a fixed sequence, each time the data is requested over the network and acquired from servers, and then the acquired data is parsed by clients and exhibited to the users. However, this solution has at least the following disadvantages: a time delay is inevitably caused, and each time the users need to wait for a while in the displayed interface before seeing the displayed merchants because network transmission takes some time, particularly in the case of low network transmission speed; each time the users access the yellow pages, data needs to be requested from the server, and thus traffic and power consumption are needed; and network conditions are mandatory, and where no network is available, nothing is displayed.

In another conventional solution, some products provide a cache mechanism. To be specific, the previously displayed information or data is cached, and where there is no available network, the previously cached pages are firstly displayed. However, in this solution, once the users clear the data, the cached data is cleared accordingly. In this case, when the users access the yellow-pages home page again, the home yellow-pages home page is initially blank, thereby affecting user experience.

### SUMMARY

One of the technical problem to be solved by embodiments of the present disclosure is to provide a method and apparatus for dynamically display yellow pages information on a mobile device, such that when yellow pages information displayed on a mobile device, speed and data instantaneity are both ensured.

An embodiment of the present disclosure provides a method for dynamically displaying yellow pages information on a mobile device. The method comprises: pre-caching yellow pages information and a defined yellow-pages home page under a raw folder; displaying the cached yellow-pages home page on a client when a user operates the client, and acquiring the yellow pages information under the raw folder and storing the yellow pages information to a client database; and requesting, by the client, the yellow pages information from a server over the network when the mobile device is connected to a network, and searching in the client database according to partial yellow pages information returned by the server to acquire complete yellow pages information and display the acquired complete yellow pages information.

An embodiment of the present disclosure provides a mobile device for dynamically displaying yellow pages information on a mobile device. The mobile device comprises: at least one processor; and a memory communicably connected with the at least one processor for storing instructions executable by the at least one processor, wherein execution of the instructions by the at least one processor causes the at least one processor to: pre-cache yellow pages information and a defined yellow-pages home page under a raw folder; display the cached yellow-pages home page on a client when a user operates the client, and acquire the yellow pages information under the raw folder and storing the yellow pages information to a client database; and request the yellow pages information from a server over the network when the mobile device is connected to a network, and search in the client database according to partial yellow pages information returned by the server to acquire complete yellow pages information and display the acquired complete yellow pages information.

An embodiment of the present disclosure provides a non-transitory computer readable medium storing program instructions for causing a computer to perform a method of: pre-caching yellow pages information and a defined yellow-pages home page under a raw folder; displaying the cached yellow-pages home page on a client when a user operates the client, and acquiring the yellow pages information under the raw folder and storing the yellow pages information to a client database; and requesting, by the client, the yellow pages information from a server over the network when the mobile device is connected to a network, and searching in the client database according to partial yellow pages information returned by the server to acquire complete yellow pages information and display the acquired complete yellow pages information.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of a yellow pages interface on a mobile phone in the related art;

FIG. 2 is a schematic flowchart illustrating a method for dynamically displaying yellow pages information on a mobile device according to a specific embodiment of the present disclosure;

FIG. 3 is a detailed schematic flowchart illustrating a method for dynamically displaying yellow pages information on a mobile device according to a specific embodiment of the present disclosure;

FIG. 4 is a schematic structural diagram illustrating an apparatus for dynamically displaying yellow pages information on a mobile device according to a specific embodiment of the present disclosure; and

FIG. 5 is a schematic structural diagram illustrating an electronic device according to the present disclosure.

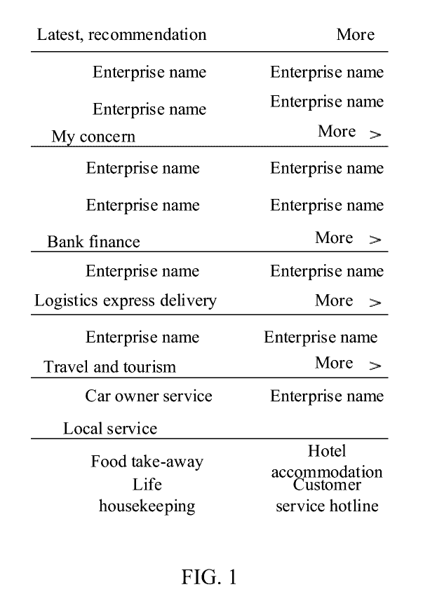

### DETAILED DESCRIPTION

Some exemplary embodiments of the present disclosure are hereinafter described in detail with reference to the accompanying drawings. Although the accompanying drawings illustrate the exemplary embodiments of the present disclosure, it shall be understood that the present disclosure may be practiced in various manners, and the present disclosure shall not be limited by the embodiments illustrated herein. On the contrary, these embodiments are described herein only for the purpose of better understanding the present disclosure, and may integrally convey the scope of the present disclosure to a person skilled in the art.

In the conventional solution, the method for displaying yellow pages information is time consuming and costly, and the method for locally caching the yellow pages information lacks flexibility. However, the disclosure overcomes the above defect, and reaches an organic combination of these two methods to form a new cache mechanism. In this mechanism, commonly used merchant databases are placed in an application package, which narrows a range of data requested from the network, and considers both the speed and data timeliness when displaying the yellow pages information on a mobile device.

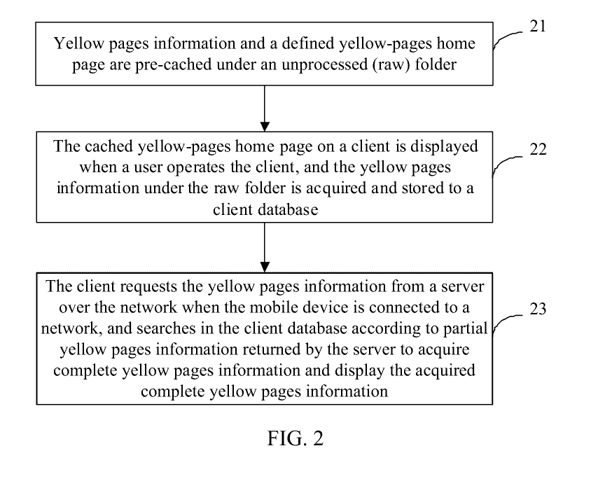

FIG. 2 is a schematic flowchart illustrating a method for dynamically displaying yellow pages information on a mobile device according to a specific embodiment of the present disclosure.

As illustrated in FIG. 2, the method is applied to a mobile device and comprises the following steps:

In step S21, yellow pages information and a defined yellow-pages home page are pre-cached under an unprocessed (raw) folder.

In step S22, the cached yellow-pages home page on a client is displayed when a user operates the client, and the yellow pages information under the raw folder is acquired and stored to a client database.

In step S23, the client requests the yellow pages information from a server over the network when the mobile device is connected to a network, and searches in the client database according to partial yellow pages information returned by the server to acquire complete yellow pages information and display the acquired complete yellow pages information.

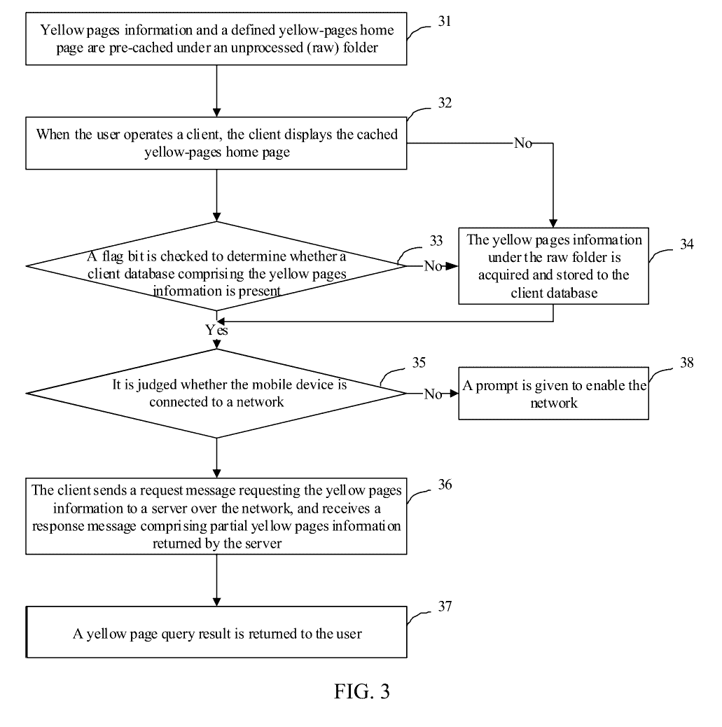

FIG. 3 is a detailed schematic flowchart illustrating a method for dynamically displaying yellow pages information on a mobile device according to a specific embodiment of the present disclosure.

As illustrated in FIG. 3, the method is applied to a mobile device and comprises the following steps:

In step S31, yellow pages information and a defined yellow-pages home page are pre-cached under an unprocessed (raw) folder.

In this step, the yellow pages information is pre-stored in a database, and the defined yellow-pages home page is stored in an Extensible Markup Language (XML) file, and a database comprising the yellow pages information and the XML file comprising the yellow-pages home page are delivered together with an Android installation package (apk, Android Package) and placed under the raw folder.

The yellow pages information mainly comprises merchant number, merchant name, merchant type, merchant logo, and URL address of merchant logo and the like.

For example, 8008200907, CASHBOX service hotline, KTV, http://.../1.png.

In the specific embodiment of the present disclosure, due to the logo document needs large storage space of the database, a corresponding URL address which needs less storage space is selected to be stored instead.

Through test, the yellow pages information data of hundreds of merchants is only tens of K bytes, and thus causes a small impact to the size of the apk when being delivered with the apk.

In addition, a display sequence of the yellow pages information is stored in the XML file comprising the cached yellow-pages home page.

As such, it is ensured that when a user clears data, the cached yellow pages information and yellow-pages home page are not cleared; and in addition, during use of the yellow pages, data of the cached yellow pages information and yellow-pages home page may be used.

In step S32, when the user operates a client, the client displays the cached yellow-pages home page.

In this step, when the client is operated by the user, it searches for the XML file under the raw folder, acquires the predefined cached yellow-pages home page from the XML file and displays the yellow-pages home page.

As such, the circumstance where the yellow-pages home page is blank when the user enters the client, and thus user experience is improved.

In step S33, a flag bit is checked to determine whether a client database comprising the yellow pages information is present; if such a client database is present, step S35 is performed; and otherwise, step S34 is performed.

In this step, as compared with the prior art, a flag bit is added in the specific embodiment of the present disclosure, wherein the flag bit is used for representing a client database comprising the yellow pages information.

If the flag bit is a first value, a client database comprising the yellow pages information is present.

If the flag bit is a second value, a client database comprising the yellow pages information is not present.

The first value and the second value each may be a value, or a symbol or a flag of another type. For example, the first value is 1 and the second value is 0; or the first value is a symbol and the second value is null. The specific form thereof is not limited in the embodiment of the present disclosure.

In step S34, the yellow pages information under the raw folder is acquired and stored to the client database, and then step S35 is performed.

In this step, if it is determined through flag bit checking that there is no client database comprising the yellow pages information, the yellow pages information in the database under the raw folder is read into the client database “/data/data/packagename/databases”.

In step S35, it is judged whether the mobile device is connected to a network; if the mobile device is connected to a network, step S36 is performed; and otherwise, step S38 is performed.

In step S36, the client sends a request message requesting the yellow pages information to a server over the network, and receives a response message comprising partial yellow pages information returned by the server.

In this step, if the mobile device is connected to the network, the client may sends information requesting the yellow pages information to the server over the network, and receives the yellow pages information returned by the server, wherein the server does not need to return detailed data of each merchant, but only needs to return partial yellow pages information thereof, for example, telephone number.

As such, partial yellow pages information is only acquired over the network, thereby reducing network transmission time and saving traffic for the user.

In step S37, a search is made in the client database according to the partial yellow pages information returned by the server, to acquire complete yellow pages information and display the acquired complete yellow pages information.

In this step, a search is made in the client database according to the partial information returned by the server to acquire the complete yellow pages information. For example, corresponding merchant name, merchant type, merchant logo and the like are searched in the client database according to the number returned by the server, and a corresponding logo is acquired according to the URL of the logo.

As such, the client refreshes the page, and displays the acquired complete yellow pages information.

In step S38, a prompt is given to enable the network.

In this step, the prompt indicates there is no network for the user right now, if the user desires to use the yellow pages, the network needs to be enabled.

The present disclosure further provides a computer readable storage medium storing a program for performing the above method.

The computer readable storage medium includes any mechanism for storing or transferring information in a computer readable form (for example, a computer). For example, the computer readable storage medium includes a read-only memory (ROM), a random access memory (RAM), a disk storage medium, an optical storage medium, a flash storage medium, electricity, light, sound and other forms of propagation signals (for example, a carrier, an infrared signal, a digital signal and the like), and the like.

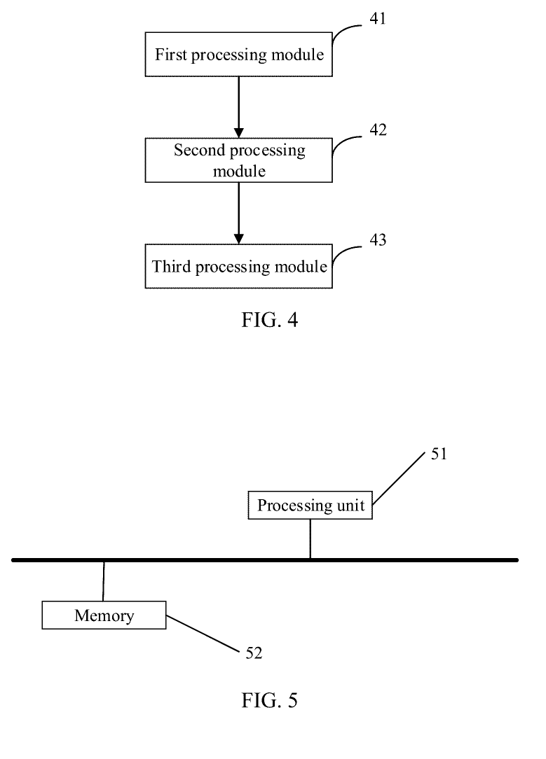

FIG. 4 is a schematic structural diagram illustrating a mobile device for dynamically displaying yellow pages information according to a specific embodiment of the present disclosure.

As illustrated in FIG. 4, the mobile device according to the present disclosure comprises:

a first processing module 41, configured to pre-cache yellow pages information and a defined yellow-pages home page under an unprocessed (raw) folder;

a second processing module 42, configured to display the cached yellow-pages home page on a client when a user operates the client, and acquire the yellow pages information under the raw folder and storing the yellow pages information to a client database; and

a third processing module 43, configured to request the yellow pages information from a server over the network when the mobile device is connected to a network, and search in the client database according to partial yellow pages information returned by the server to acquire complete yellow pages information and display the acquired complete yellow pages information.

To be specific:

The first processing module is specifically configured to: pre-store the yellow pages information to a database; store the defined yellow-pages home page to an XML file; and deliver the database comprising the yellow pages information and the XML file comprising the yellow-pages home page together with an Android installation package, and place the yellow-pages home page and the Android installation package under the raw folder; wherein the yellow pages information comprises merchant number, merchant name, merchant type, merchant logo, and URL address of merchant logo.

The second processing module is specifically configured to: when the user operates the client, search for the XML file under the raw folder, and acquire the predefined cached yellow-pages home page from the XML file and display the yellow-pages home page; and check a flag bit to judge whether a client database comprising the yellow pages information is present; wherein if the flag bit is a first value, a client database comprising the yellow pages information is present; or if the flag bit is a second value, a client database comprising the yellow pages information is not present, and the yellow pages information under the raw folder is acquired and stored to the client database.

The third processing module is specifically configured to: judge whether the mobile device is connected to a network; if the mobile device is connected to a network, send a request message requesting the yellow pages information to the server, and receive a response message comprising partial yellow pages information returned by the server, wherein the partial yellow pages information is merchant number in the yellow pages information; and search in the client database according to the partial yellow pages information returned by the server to acquire complete yellow pages information and display the acquired complete yellow pages information, wherein the yellow pages information comprises merchant number, merchant name, merchant type, merchant logo, and URL address of merchant logo; if the mobile device is not connected to a network, prompt to enable the network.

According to the present disclosure, by placing commonly used merchant databases into an application package, a range of the data requested from the network is narrowed, and when yellow pages information displayed on a mobile device, speed and data instantaneity are both ensured.

Referring to FIG. 5, another embodiment of the present disclosure further provides an electronic device, which has the same functions as those of the apparatus illustrated in FIG. 4. The device as illustrated in FIG. 5 includes at least one central processing unit 51 and a memory 52. The memory 52 and the at least one central processing unit 51 are connected via a bus. The memory 52 is configured to store computer instructions. When the apparatus is executed, the at least one central processing unit 51 performs the computer instructions stored in the memory to cause the apparatus to perform the steps in the methods as illustrated in FIG. 2 and FIG. 3.

Another embodiment of the present disclosure further provides a non-transitory computer-readable storage medium storing executable instructions that, when executed by an electronic device, cause the electronic device to: pre-caching yellow pages information and a defined yellow-pages home page under a raw folder; displaying the cached yellow-pages home page on a client when a user operates the client, and acquiring the yellow pages information under the raw folder and storing the yellow pages information to a client database; and requesting, by the client, the yellow pages information from a server over the network when the mobile device is connected to a network, and searching in the client database according to partial yellow pages information returned by the server to acquire complete yellow pages information and display the acquired complete yellow pages information.

The algorithms and displays provided herein are not inherently related to any specific computer, virtual system or other device. Various general-purpose systems may also be used with the teachings herein. According to the above description, the structure required for constructing such systems is obvious. In addition, the present disclosure is not directed to any specific programming language. It should be understood that the content of the present disclosure described herein may be carried out utilizing various programming languages, and that the above description for a specific language is for the sake of disclosing preferred embodiments of the present disclosure.

In the specification provided herein, a plenty of particular details are described. However, it can be appreciated that an embodiment of the present disclosure may also be practiced without these particular details. In some embodiments, well known methods, structures and technologies are not illustrated in detail so as not to obscure the understanding of the specification.

Likewise, it shall be understood that, to streamline the present disclosure and facilitate understanding of one or more of various aspects of the present disclosure, in the above description of the exemplary embodiments of the present disclosure, various features of the present disclosure are sometimes incorporated in an individual embodiment, drawing or description thereof. However, the method according to the present disclosure shall not be explained to embody the following intension: the present disclosure seeking protection claims more features than those explicitly disclosed in each of the appended claims. To be more exact, as embodied in the appended claims, the inventive aspects lie in that fewer features than all the features embodied in an individual embodiment as described above. Therefore, the claims observing the specific embodiments are herein incorporated into the specific embodiments, and each claim may be deemed as an individual embodiment of the present disclosure.

Those skilled in the art should understand that modules in the devices according to the embodiments may be adaptively modified and these modules may be configured in one or more devices different from the embodiments herein. Modules or units or components in the embodiments may be combined into a single module or unit or component, and additionally these modules, units or components may be practiced in a plurality of submodules, subunits or subcomponents. Besides that such features and/or processes or at least some of the modules are mutually exclusive, all the features disclosed in this specification (including the appended claims, abstract and accompanying drawings) and all the processes or modules in such disclosed methods or devices may be combined in any way. Unless otherwise stated, each of the features disclosed in this specification (including the appended claims, abstract and accompanying drawings) may be replaced by a provided same, equivalent or similar substitution.

In addition, those skilled in the art shall understand that, although some embodiments described herein include some features included in other embodiments, rather than other features, a combination of the features in different embodiments signifies that the features are within the scope of the present disclosure and different embodiments may be derived. For example, in the claims appended hereinafter, any one of the embodiments seeking protection may be practiced in any combination manner.

Embodiments of the individual components of the present disclosure may be implemented in hardware, or in a software module running one or more processors, or in a combination thereof. It will be appreciated by those skilled in the art that, in practice, some or all of the functions of some or all of the components in the message prompting apparatus according to individual embodiments of the present disclosure may be implemented using a microprocessor or a digital signal processor (DSP). The present disclosure may also be implemented as an apparatus of a device program (e.g., a computer program and a computer program product) for performing a part or all of the method as described herein. Such a program implementing the present disclosure may be stored on a computer readable medium, or may be stored in the form of one or more signals. Such a signal may be obtained by downloading it from an Internet website, or provided on a carrier signal, or provided in any other form.

Reference herein to “one embodiment”, “an embodiment” or to “one or more embodiments” implies that a particular feature, structure, or characteristic described in connection with the embodiments is included in at least one embodiment of the present disclosure. Further, it should be noted that instances of the phrase “in one embodiment” herein are not necessarily all referring to the same embodiment.

In the specification provided herein, a plenty of particular details are described. However, it can be appreciated that an embodiment of the present disclosure may also be practiced without these particular details. In some embodiments, well known methods, structures and technologies are not illustrated in detail so as not to obscure the understanding of the specification.

It should be noted that the above embodiments illustrate rather than limit the present disclosure, and those skilled in the art may design alternative embodiments without departing from the scope of the appended claims. In the claims, any reference sign placed between the parentheses shall not be construed as a limitation to a claim. The word “comprise” does not exclude the presence of an element or a step not listed in a claim. The word “a” or “an” preceding an element does not exclude the presence of a plurality of such elements. The present disclosure may be implemented by means of a hardware comprising several distinct elements and by means of a suitably programmed computer. In a unit claim enumerating several devices, several of the devices may be embodied by one and the same hardware item. Use of the words “first”, “second”, “third” and the like does not mean any ordering. Such words may be construed as naming.

What is claimed is:

1. A method for dynamically displaying yellow pages information on a mobile device, comprising:
pre-caching yellow pages information and a predefined yellow-pages home page under a raw folder;
displaying the cached yellow-pages home page on a client when a user operates the client, and acquiring the yellow pages information under the raw folder and storing the yellow pages information to a client database; and
requesting, by the client, the yellow pages information from a server over a network when the mobile device is connected to the network, and searching in the client database according to part of the yellow pages information returned by the server, in order to acquire complete yellow pages information and display the acquired complete yellow pages information.

2. The method for dynamically displaying yellow pages information on a mobile device according to claim 1, wherein the step of pre-caching yellow pages information and a defined yellow-pages home page under a raw folder comprises:
pre-storing the yellow pages information to a database;
storing the defined yellow-pages home page to an XML file; and
delivering the database comprised of the yellow pages information and the XML file comprised of the yellow-pages home page together with an Android installation package, and storing them to the raw folder.

3. The method for dynamically displaying yellow pages information on a mobile device according to claim 2, wherein the yellow pages information comprises:
merchant number, merchant name, merchant type, merchant logo, and URL address of merchant logo.

4. The method for dynamically displaying yellow pages information on a mobile device according to claim 3, wherein the step of displaying the cached yellow-pages home page on a client when a user operates the client, and acquiring the yellow pages information under the raw folder and storing the yellow pages information to a client database comprises:
when the user operates the client, searching for the XML file under the raw folder, and acquiring the predefined yellow-pages home page from the XML file and displaying the yellow-pages home page; and
checking a flag bit to judge whether a client database comprising the yellow pages information is present; wherein
if the flag bit is a first value, a client database comprising the yellow pages information is present; or
if the flag bit is a second value, a client database comprising the yellow pages information is not present, and the yellow pages information under the raw folder is acquired and stored to the client database.

5. The method for dynamically displaying yellow pages information on a mobile device according to claim 3, wherein the step of requesting, by the client, the yellow pages information from a server over a network when the mobile device is connected to the network, and searching in the client database according to part of the yellow pages information returned by the server, in order to acquire complete yellow pages information and display the acquired complete yellow pages information comprises:
judging whether the mobile device is connected to a network;
if the mobile device is connected to a network, sending, by the client, a request message requesting the yellow pages information to the server, and receiving a response message comprising partial yellow pages information returned by the server; and searching in the client database according to the partial yellow pages information returned by the server to acquire complete yellow pages information and display the acquired complete yellow pages information; or
if the mobile device is not connected to a network, prompting to enable the network.

6. The method for dynamically displaying yellow pages information on a mobile device according to claim 5, wherein the part of the yellow pages information is merchant number in the yellow pages information; and
the step of searching in the client database according to part of the yellow pages information returned by the server, in order to acquire complete yellow pages information and display the acquired complete yellow pages information comprises:
searching in the client database for corresponding merchant number, merchant name, merchant type, merchant logo, and URL address of merchant logo according to the number returned by the server, and acquiring the merchant logo according to the URL address of merchant logo.

7. A mobile device for dynamically displaying yellow pages information, comprising:
at least one processor; and
a memory communicably connected with the at least one processor for storing instructions executable by the at least one processor, wherein execution of the instructions by the at least one processor causes the at least one processor to:
pre-cache yellow pages information and a defined yellow-pages home page under a raw folder;
display the cached yellow-pages home page on a client when a user operates the client, and acquire the yellow pages information under the raw folder and storing the yellow pages information to a client database; and
request the yellow pages information from a server over the network when the mobile device is connected to a network, and search in the client database according to partial yellow pages information returned by the server to acquire complete yellow pages information and display the acquired complete yellow pages information.

8. The mobile device for dynamically displaying yellow pages information according to claim 7, wherein the instructions to pre-cache yellow pages information and a defined yellow-pages home page under a raw folder cause the at least one processor to:
pre-store the yellow pages information to a database;
store the defined yellow-pages home page to an XML file; and
deliver the database comprising the yellow pages information and the XML file comprising the yellow-pages home page together with an Android installation package, and place the yellow-pages home page and the Android installation package under the raw folder;
wherein the yellow pages information comprises merchant number, merchant name, merchant type, merchant logo, and URL address of merchant logo.

9. The mobile device for dynamically displaying yellow pages information according to claim 8, wherein the instructions to display the cached yellow-pages home page on a client when a user operates the client, and acquire the yellow pages information under the raw folder and storing the yellow pages information to a client database cause the at least one processor to:
when the user operates the client, search for the XML file under the raw folder, and acquire the predefined cached yellow-pages home page from the XML file and display the yellow-pages home page; and
check a flag bit to judge whether a client database comprising the yellow pages information is present; wherein
if the flag bit is a first value, a client database comprising the yellow pages information is present; or
if the flag bit is a second value, a client database comprising the yellow pages information is not present, and the yellow pages information under the raw folder is acquired and stored to the client database.

10. The mobile device for dynamically displaying yellow pages information according to claim 9, wherein the instructions to request the yellow pages information from a server over the network when the mobile device is connected to a network, and search in the client database according to partial yellow pages information returned by the server to acquire complete yellow pages information and display the acquired complete yellow pages information causes the at least one processor to:
judge whether the mobile device is connected to a network;
if the mobile device is connected to a network, send a request message requesting the yellow pages information to the server, and receive a response message comprising partial yellow pages information returned by the server, wherein the partial yellow pages information is merchant number in the yellow pages information; and
search in the client database according to the partial yellow pages information returned by the server to acquire complete yellow pages information and display the acquired complete yellow pages information, wherein the yellow pages information comprises merchant number, merchant name, merchant type, merchant logo, and URL address of merchant logo; and
if the mobile device is not connected to a network, prompt to enable the network.

11. A non-transitory computer readable medium, storing program instructions that when executed by a mobile device, cause the mobile device to:
pre-cache yellow pages information and a defined yellow-pages home page under a raw folder;
display the cached yellow-pages home page on a client when a user operates the client, and acquire the yellow pages information under the raw folder and storing the yellow pages information to a client database; and
request, by the client, the yellow pages information from a server over the network when the mobile device is connected to a network, and search in the client database according to partial yellow pages information returned by the server to acquire complete yellow pages information and display the acquired complete yellow pages information.

12. The non-transitory computer readable medium according to claim 11, wherein to pre-cache yellow pages information and a defined yellow-pages home page under a raw folder, the execution of the instructions further cause the mobile device to:
pre-store the yellow pages information to a database;
store the defined yellow-pages home page to an XML file; and
deliver the database comprised of the yellow pages information and the XML file comprised of the yellow-pages home page together with an Android installation package, and storing them to the raw folder.

13. The non-transitory computer readable medium according to claim 12, wherein the yellow pages information:
merchant number, merchant name, merchant type, merchant logo, and URL address of merchant logo.

14. The non-transitory computer readable medium according to claim 13, wherein to display the cached yellow-pages home page on a client when a user operates the client, and acquire the yellow pages information under the raw folder and storing the yellow pages information to a client database, the execution of the instructions further cause the mobile device to:
when the user operates the client, search for the XML file under the raw folder, and acquire the predefined yellow-pages home page from the XML file and displaying the yellow-pages home page; and
check a flag bit to judge whether a client database comprising the yellow pages information is present; wherein
if the flag bit is a first value, a client database comprising the yellow pages information is present; or
if the flag bit is a second value, a client database comprising the yellow pages information is not present, and the yellow pages information under the raw folder is acquired and stored to the client database.

15. The non-transitory computer readable medium according to claim 13, wherein the instructions to request, by the client, the yellow pages information from a server over a network when the mobile device is connected to the network, and search in the client database according to part of the yellow pages information returned by the server, in order to acquire complete yellow pages information and display the acquired complete yellow pages information cause the mobile device to:
judge whether the mobile device is connected to a network;
if the mobile device is connected to a network, send, by the client, a request message requesting the yellow pages information to the server, and receive a response message comprising partial yellow pages information returned by the server; and search in the client database according to the partial yellow pages information returned by the server to acquire complete yellow pages information and display the acquired complete yellow pages information; or
if the mobile device is not connected to a network, prompt to enable the network.

16. The non-transitory computer readable medium according to claim 15, wherein the part of the yellow pages information is merchant number in the yellow pages information; and
the instructions to search in the client database according to part of the yellow pages information returned by the server, in order to acquire complete yellow pages information and display the acquired complete yellow pages information cause the mobile device to:
search in the client database for corresponding merchant number, merchant name, merchant type, merchant logo, and URL address of merchant logo according to the number returned by the server, and acquire the merchant logo according to the URL address of merchant logo.
